(19) United States
(12) Patent Application Publication
(10) Pub. No.: US 2017/0054849 A1
(43) Pub. Date: Feb. 23, 2017

(54) SYSTEM FOR REDUCING WAIT TIME FOR QUEUING CUSTOMERS

(71) Applicant: TimeTrade Systems, Inc., Tewksbury, MA (US)

(72) Inventors: Brent Torre, Tewksbury, MA (US); Bill Stearns, Tewksbury, MA (US); Sharon Harris, Tewksbury, MA (US); Brian Kelly, Tewksbury, MA (US)

(21) Appl. No.: 15/235,405

(22) Filed: Aug. 12, 2016

Related U.S. Application Data
(60) Provisional application No. 62/206,383, filed on Aug. 18, 2015.
(60) Provisional application No. 62/206,384, filed on Aug. 18, 2015.

(51) Int. Cl. H04M 3/51; G06Q 30/02; H04L 12/58; H04M 3/523; H04W 4/12; H04L 29/08

(52) U.S. Cl. CPC H04M 3/5191; H04W 4/12; H04L 67/146; H04L 51/04; H04M 3/5141; H04M 3/5238; G06Q 30/0271; H04L 67/22

(57) ABSTRACT

A method is provided for customer queuing management. At an application server, a queuing request may be received from a user when the user enters a queue. A message may be sent to a user device of the user. The message may contain a link to a web resource. A request to connect to the web resource may be received. A web page may be sent to the user device. The web page may indicate the user's position in the queue and include a prompt to initiate a live chat session. A request may be received from the user device to initiate the live chat session with an agent and the live chat session between the user and the agent may be initiated to handle a request of the user. In addition, the web page may include targeted, highly personalized advertising based on user information.

### PRIORITY CLAIM

This application claims priority to U.S. Provisional Patent Application No. 62/206,383, filed Aug. 18, 2015, entitled “System for Reducing Wait Time for Queuing Customers,” and to U.S. Provisional Patent Application No. 62/206,384, filed Aug. 18, 2015, entitled “Mobile Phone-Based Method for Personalized Advertising for Customers Waiting in a Queue.” The entirety of each of these prior applications is incorporated herein by reference.

### TECHNICAL FIELD

The present disclosure relates generally to queue management for customers who use mobile devices to enter a queue for customer service requests.

### BACKGROUND

Customers often come to retail locations or other types of facilities that provide in-person service for customer service requests. A lot of times, customers have to wait in queues for some time before they can speak to someone at a service desk about their service requests. Now with mobile devices becoming ubiquitous, a lot of customers spend their time using their mobile devices while waiting in queues. This is an inefficient use of time for the customers and a missed opportunity for vendors to provide customer service.

### BRIEF DESCRIPTION OF THE DRAWINGS

FIG. 1 is a block diagram illustrating a message received by a customer who has checked into a customer service queue using a mobile device according to an example embodiment.

FIG. 2 is a block diagram illustrating a “status page” on a mobile device according to an example embodiment.

FIG. 3 is a block diagram illustrating a message-based interaction between a customer already in a queue and a remote support representative according to an example embodiment.

FIG. 4 is a block diagram illustrating an alternative “status page” on a mobile device according to another example embodiment.

FIG. 5 is a block diagram illustrating a system for implementing customer queue management according to an example embodiment.

FIG. 6 is a block diagram illustrating an apparatus for implementing customer queue management according to an example embodiment.

FIG. 7 is a flow chart for illustrating operations to be performed for customer queue management at a high-level according to an example embodiment.

### SUMMARY OF INVENTION

Presented herein is a system and method for serving customer requests while a customer is still waiting in a queue, such as waiting for a service, sales or other related question or assistance. Customer mobile communication information may be requested and received when a customer enters a queue at a location, e.g., for customer service, a sales question, or other purpose. The mobile communication information may include, for example, a mobile phone number, a social media contact identifier, email address, etc. A message, for example, a Multimedia Messaging Service (MMS) or text message, may be sent to the customer's user device. The message may include a web Uniform Resource Locator (URL) that, when selected, loads a mobile web application on the user device or redirects to a web application using the user device's Internet browser. The web application may show the customer's position in the queue and estimated wait time. The web application also may allow the customer to interact with remote service personnel who can handle the customer request over a live chat channel. The live chat session is a parallel communication channel separate from the in-person wait/queue shown to the user/customer by the web application. In other words, the in-person queuing function is augmented with an alternative live chat channel. Thus, a customer may be serviced before the customer even reaches the top of the queue. In addition, the web application may include targeted, highly personalized advertising based on data gathered on the customer, such as, but not limited to, the customer's requested service type, customer's previous transactions with the service provider, browsing history, social media activity, market segment, demographic, or statistical likelihood of purchasing a certain product.

### DETAILED DESCRIPTION OF EXAMPLE EMBODIMENTS

Techniques are provided for managing customer service queues. Embodiments include a system and method that empowers the customer to get assistance from a digital “live chat” support channel while still queuing inline. The live chat is a parallel channel separate from. the in-person wait/queue shown to the user/customer by the web application. In one embodiment, a service provider (e.g., a retailer or a provider for other services) may offer its customers a method to get in a queue for service at one of its locations using devices such as mobile phones, laptops, tablets, and desktop computers. This queue may be referred to as a virtual queue. Upon entering the virtual queue online, a customer may receive a text-based or MMS message to the customer's user device based on a mobile number the customer was asked to supply when entering the queue. The text-based or MMS message information may include an estimated wait time, a customer's current place in the queue, and a web URL (link) that the customer is instructed to view from on the user device while waiting in a queue for service. When the customer accesses the URL on the user device, a web page is loaded onto a web browser of the user device or redirects to a web application using the user device's Internet browser or a native screen of the user device. The web page may have a link that offers the customer to “chat live.” By selecting the link, the customer may initiate a web chat session from the user device with a remotely located customer service representative employed by the service provider or retailer. The remote representative—available instantly and without any queuing delay—may be able to handle the customer service requests for the customer. The customer's information and reason for being in queue is passed to the remote chat agent so that the agent has the context of the customer's needs.

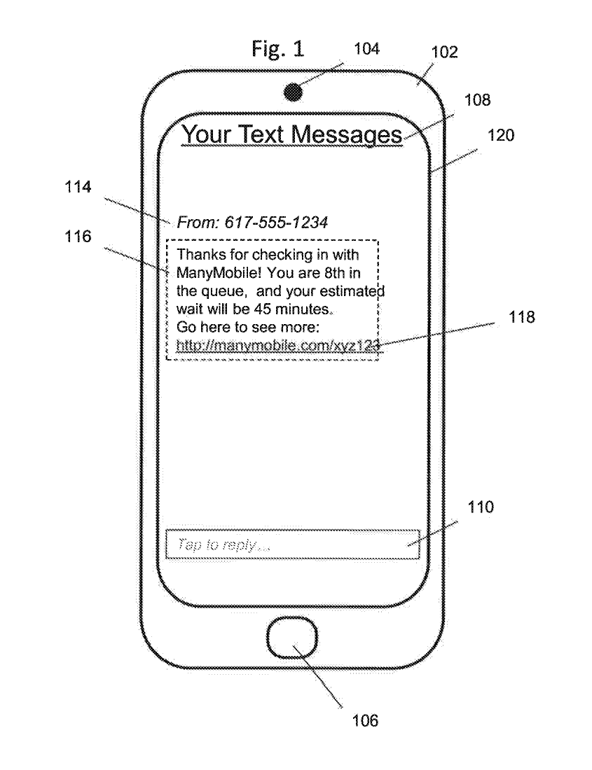

Reference is made first to FIG. 1, in which a block diagram shows a mobile device 102 according to an example embodiment. The mobile device 102 may comprise an input/output unit 104, a button 106 and a display 120. The input/output unit 104 may be, for example, a camera or a speaker. The button 106 may be a control button (e.g., a home button) of the mobile device 102. The display 120 may show an text-based or MMS message 108 received by a customer who has checked into a customer service queue and given a mobile number associated with the mobile device 102. The text-based or MMS message 108 may include sender information 114 and a message body 116. The sender information 114 may comprise a phone number that sends the text-based or MMS message 108. The message body 116 may show a welcome message, which may include a short description of the customer service queue information, such as, but not limited to, the customer's position in the queue and estimated time to wait. In addition, the message body 116 may comprise a link 118 to a web resource. The display 120 may also include a reply text box 110, which the customer may tap and type in a reply to the text-based or MMS message 108. In one embodiment, only that specific customer's/user's position in the queue and estimated wait time is displayed, and this is updated in real-time. This may be preferable to display all customers and their positions (typically represented by name, phone number or ‘Ticket’ number) in a long list.

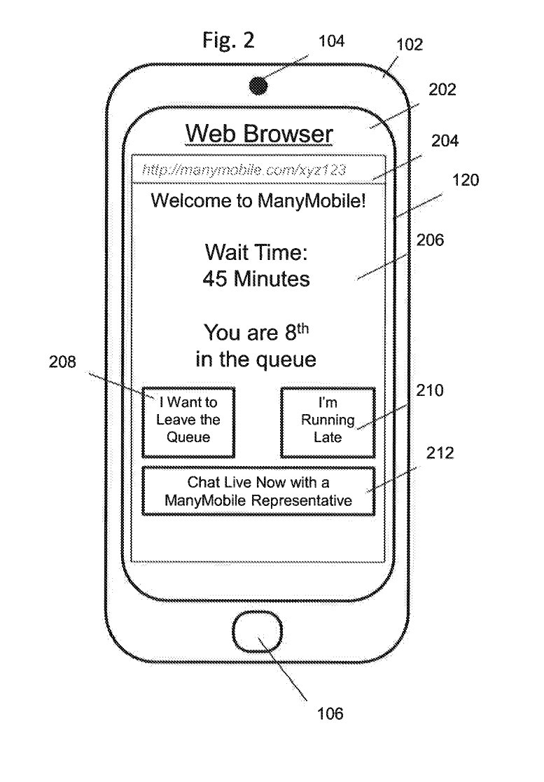

FIG. 2 illustrates a “status page” on the mobile device 102 according to an example embodiment. Once the customer taps on the link 118, a web page may be loaded onto a web browser 202 of the mobile device 102. The web page may be a personalized “status page,” and may offer the customer a variety of information, for example, a web address 204 that shows the address of the web page, a welcome information display 206 that may include the current estimated wait time and the customer's place in the queue. The web page may also include a few buttons. For example, a button 208 for the customer to leave the queue and abandon the customer's position in the queue, a button 210 to ask for an expedited service. In addition, the web page may include a chat button 212 which may offer the customer an option to initiate a live chat with a remote customer service representative. In some embodiments, the web page may include other information, such as, but not limited to, nearby locations and phone numbers of the service provider (e.g., a fictitious mobile service vendor ManyMobile as shown in the FIGS. 1-4).

It should be noted that, in some embodiments, one or more buttons 208, 210 and 212 may be replaced with links, and the link 118 may be replaced with a button.

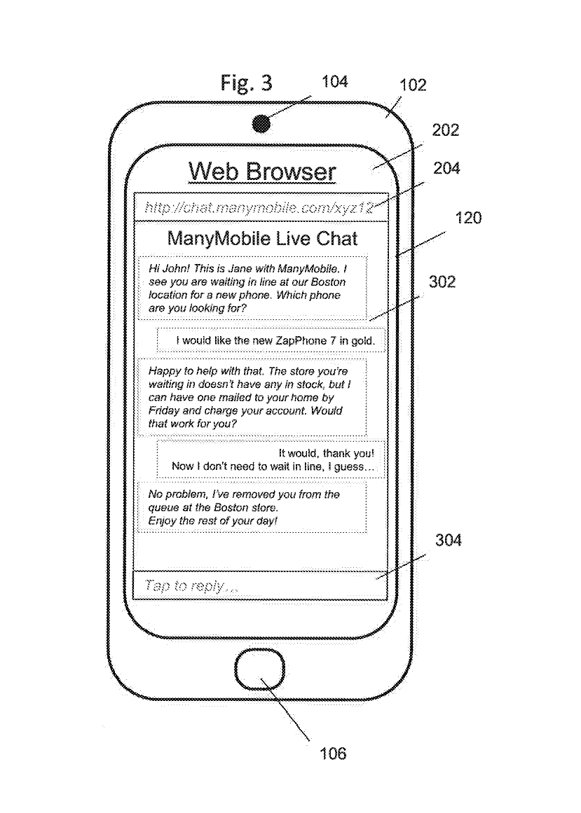

FIG. 3 shows a text-based live chat session according to an example embodiment. The text live chat session may be carried in the web browser 202 with its web address shown in the web address 204. The web browser 202 may comprise a display area 302 to display the text of the live chat session and an input area 304 for the customer to type in texts. The example in FIG. 3 shows a messaging interaction for a customer wishing to upgrade the customer's mobile phone device with the existing mobile service provider. The live chat session may be initiated once the customer selects the chat button 212 on FIG. 2.

At the other end of the live chat session may be a remote customer service representative working for the service provider. This remote representative—available instantly and without any queuing delay—may be able to handle and resolve a number of customer issues. In one embodiment, at the moment the chat session is initiated, the remote representative may be presented immediately with data about the customer who requested the chat session: the customer's phone number (which can be used to look up the customer's full account details), the type of service the customer is queuing in line to receive, the amount of time the customer has been in line already, the estimated wait time that is remaining, and the location the customer is currently waiting at. The remote representative may use this information to initiate an informed and optimized discussion with the customer, alleviating the need to ask the customer for information that has already been provided or would otherwise be frustrating for the customer to provide.

In one embodiment, the customer may choose from a variety of different communication technologies to interact with the remote representative: text-based or MMS messaging or other vendor-specific protocols (e.g., iMessage™), an audio conversation over Voice over Internet Protocol (VoIP), a regular phone call (by the customer agreeing to have the representative phone the customer's mobile phone number), the agent can send product videos or pictures over an MMS message, or a face-to-face video chat using the front-screen camera available on many modern mobile phones (e.g., the input/output unit 104).

In some embodiments, while being assisted, the customer may remain in the original queue in case the remote representative is unable to assist the customer. However, if the customer's issue gets resolved by the remote representative, the customer may abandon the customer's place in the queue. For example, the customer may move back to the web page shown in FIG. 2 and push the button 208. Alternatively, the remote representative may offer to do this for the customer.

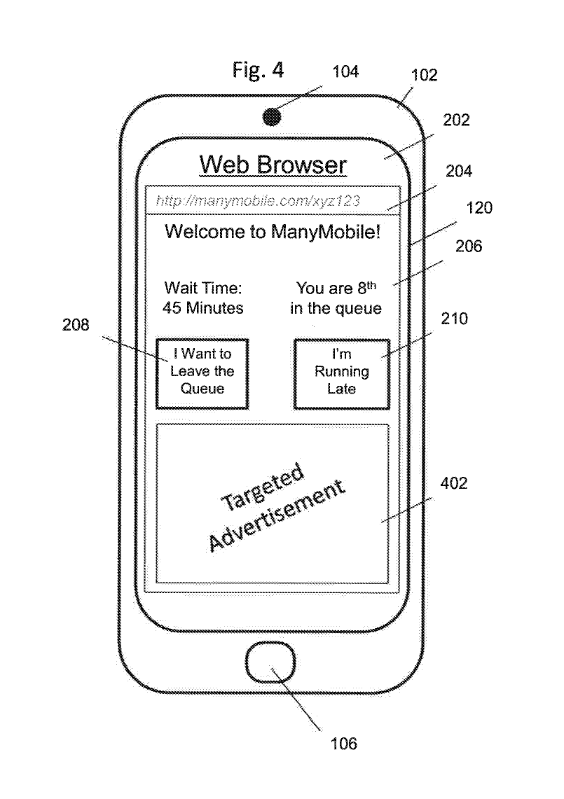

Reference is made to FIG. 4, in which an alternative “status page” is shown on the mobile device 102 according to another example embodiment. The status page in FIG. 4 may comprise the web browser 202 that includes the web address 204, the welcome information display 206 and the buttons 208 and 210 as shown in FIG. 2. In addition, the status page of FIG, 4 may comprise a display area 402 to show advertisement. In one embodiment, the advertisement may be personalized. Based on the mobile phone number provided when entering the queue, the service provider (or retailer) may obtain the customer's profile, and using the profile to determine what products or services the customer may be interested in. The marketing system of the service provider (or retailer) may quickly select a few advertisements (e.g., digital media) from a variety of possible digital media (each representing different advertisements for products or services, or perhaps the offerings of affiliates). The decision of which advertisement(s) to display is informed heavily by the data available to the system at the time of the status page being requested from the web servers.

The advertisement displayed may be highly relevant to the customer looking at the mobile phone, since the system may know a lot of accurate and up-to-date information about the customer's needs. For example, at a minimum, the system may know the customer's history with the provider (using the phone number to look up past interactions or transactions, if any) and also the type of assistance the customer is queuing for (since that may have been collected at check-in time). The customer is more likely to tap on the displayed advertisements to learn more about the offering that eventually gets displayed because the most appropriate advertisements have been pulled and displayed.

To further improve the success of this advertising channel, even more information can be used to refine the choice of advertising that the customer sees while in line. For example, taking into account the customer's recent browsing activity on the retailer's own web site or the customer's recent social media activity can increase the success of the advertising channel even further. In addition, other data such as the customer's requested service type, market segment, demographic, or their statistical likelihood of purchasing a certain product may also be taken into account.

Although the advertisement display area 402 is not shown on the status page of FIG. 2 and the chat button 212 is not shown on the status page of FIG. 4, in one embodiment, a status page may comprise both the chat button 212 and the advertisement display area 402.

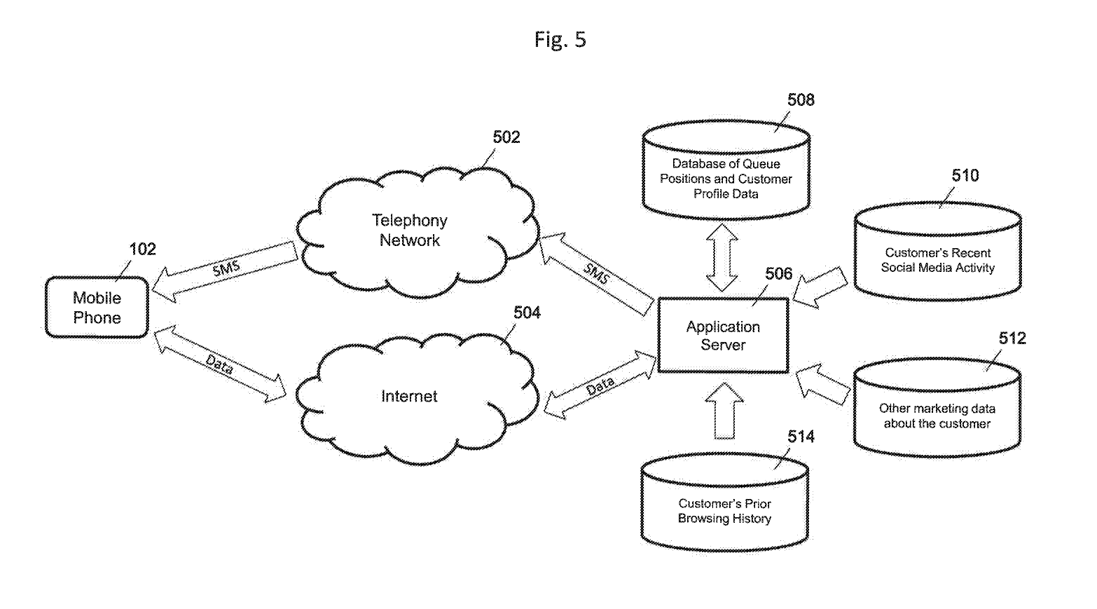

FIG. 5 is a block diagram illustrating a queue management system 500 of the entities involved in the process depicted in FIGS. 1-4 according to an embodiment. The queue management system 500 may comprise the mobile device 102, a telephony network 502, an Internet 504, an application server 506. The mobile device 102 of a customer may connect to the application server 506 by way of the telephony network 502 (for message communication) and/or the Internet 504 (for data exchanges). The application server 506 may be coupled to a database 508 of queue positions and customer profile data, a database 514 of a customer prior browsing history, a database 510 of customer recent social media activity, and a database 512 of other marketing data about the customer. In some embodiments, one or more of the databases 508, 510, 512 and 314 may be combined and may located at the application server 306. The operations described herein may be embodied by software running on the application server 506.

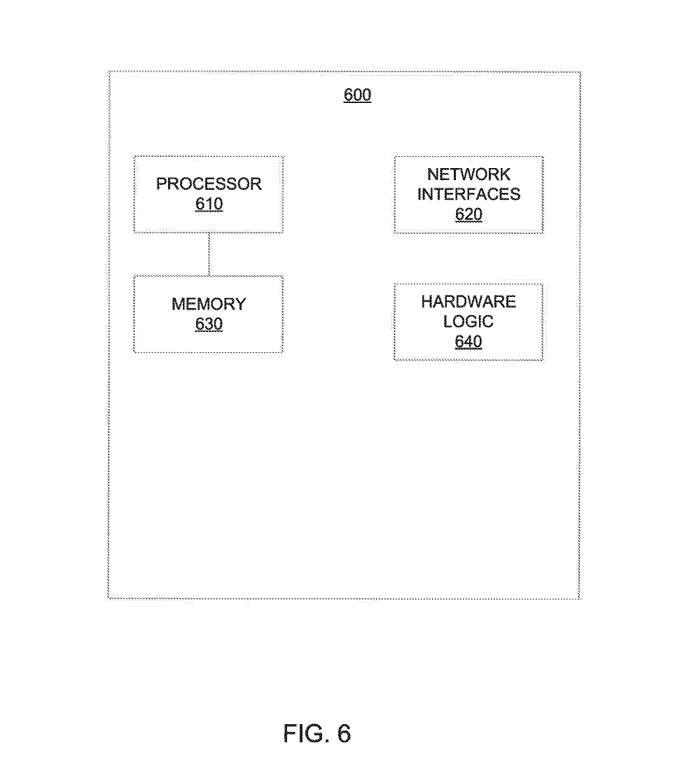

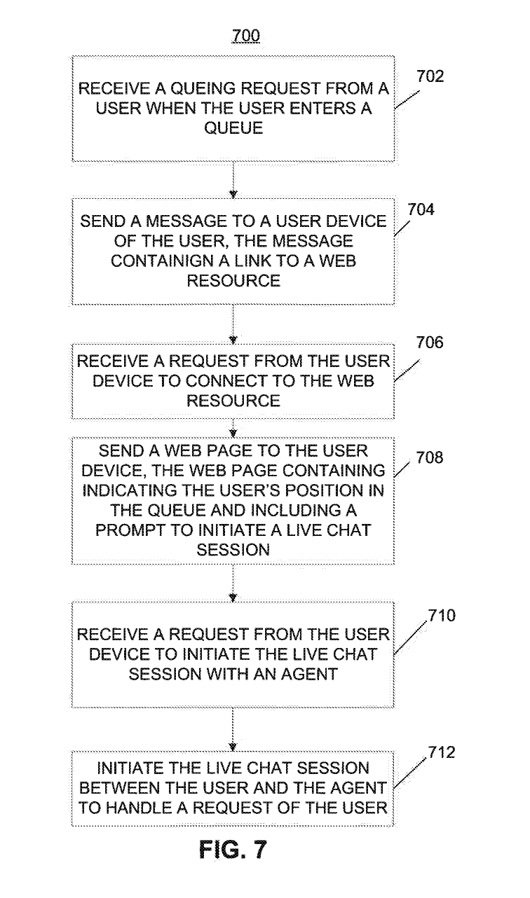

With reference to FIG. 6, there is an illustration of an example architecture of a computing apparatus 600 to implement the queue management system according to an embodiment. The apparatus 300 may comprise a network interface 620 to interface the entities shown in FIG. 5, one or more processors 610 and a memory 630. Resident in the memory 630 may be queue management software, which may include instructions that, when executed by the one or more processors, causes the queue manage system 500 to perform the operations described and shown herein, which may include operational processes for generating welcome messages, status pages, and carrying out the live chat sessions described above, and is further described in connection with FIG. 7.

The processor 610 may be, for example, a microprocessor, a microcontroller, systems on a chip (SOCs), or other fixed or programmable logic. The memory 630 may include read only memory (ROM), random access memory (RAM), magnetic disk storage media devices, optical storage media devices, flush memory devices, electrical, optical, or other physical/tangible memory storage devices. The memory 630 may be separate or part of the processor 610. Thus, in general, the memory 630 may comprise one or more tangible (e.g., non-transitory) computer readable storage media (e.g., a memory device) encoded with software comprising computer executable instructions and when the software is executed (by the processor 610) it is operable to perform the operations described herein in connection with the queue management system. To this end, the memory 630 may store software instructions that, when executed by the processor 610, cause the processor 610 to perform a variety of operations for queue management described herein. For example, the memory 630 may store instructions for the processor 610 to perform the operations described herein in connection with FIGS. 1-4 above and the process 700 as shown in FIG. 7 and described below. Process 700 may also be implemented in hardware using hardware logic, or be implemented in a combination of both hardware and software.

The functions of the processor 610 may be implemented by a processor or computer readable tangible non-transitory medium encoded with instructions or by logic encoded in one or more circuits (e.g., embedded logic such as an application specific integrated circuit (ASIC), digital signal processor (DSP) instructions, software that is executed by a processor, etc.), wherein the memory 630 stores data used for the computations or functions described herein (and/or to store software or processor instructions that are executed to carry out the computations or functions described herein). Thus, functions of the process 700 may be implemented with fixed logic or programmable logic (e.g., software or computer instructions executed by a processor or field programmable gate array (FPGA)).

It should be appreciated that in other embodiments, the apparatus 600 may include fewer or more modules apart from those shown in FIG. 6. In another example, the process 700 may be in the form of firmware that is processed by Application Specific Integrated Circuits (ASICs), which may be integrated into a circuit board. Alternatively, the process 700 may be in the form of one or more logic blocks included in a programmable logic device (e.g., a field programmable gate array). Moreover, the apparatus 600 may be adapted, and/or additional structures may be provided, to provide alternative or additional functionalities beyond those specifically discussed in reference to FIG. 7. Modifications or additions to the structures described in relation to FIG. 6 to implement these alternative or additional functionalities are envisioned without departing from the scope and spirit of the embodiments presented herein.

Referring to FIG. 7, an example flowchart is shown that generally depicts the operations of a queue management system to generate messages, status pages and support live chat sessions in parallel with presenting and updating a user's position in the queue, according to the techniques described herein. At 702, at an application server, a queuing request may be received from a user when the customer enters a queue. In some embodiments, the queuing request may be contained in a mobile phone number associated with a mobile device of the user. The queuing request may be received from mobile user device of the user. The user device may be a mobile phone (Smartphone), laptops, tablet, desktop computer or any other suitable user device now known or hereinafter developed.

At 704, a message may be sent to the user device of the user. The message may contain a link to a web resource. At 706, a request to connect to the web resource may be received from the user device. At 708, a web page may be sent to the user device. The web page may indicating (e.g., display) the user's position in the queue and include a prompt (e.g., a link or button) to initiate a live chat session. As described herein, in one embodiment, the live chat session may be a chat with a remote representative or agent, who may have access to the user's profile. At 710, a request to initiate the live chat session may be received from the user device and at 712, the live chat session may be initiated between the user (the user's device) and the agent to handle a request of the user.

The techniques provided herein may provide a way for resolving a customer service request before the customer reaches the front of a (long) queue. In the embodiments described herein, a message may be sent to the customer to invite a live chat session with a remote customer service representative to resolve the customer service request. The queue management system using such techniques may also provide personalized advertisements. Accordingly, better customer service may be provided and increased customer satisfaction may be obtained.

In summary, in one form, a method is provided comprising: at an application server, receiving a queuing request from a user when the user enters a queue; sending a message to a user device of the user, the message containing a link to a web resource; receiving a request from the user device to connect to the web resource; sending a web page to the user device, the web page indicating the user's position in the queue and including a prompt to initiate a live chat session; receiving a request from the user device to initiate the live chat session with an agent; and initiating the live chat session between the user and the agent to handle the request of the user.

In summary, in another form, a system may be configured to provide customer queuing management. The system may comprise: a network interface configured to receive and transmit network communications; one or more processors coupled to the network interface and configured to execute computer program instructions to: receive a queuing request from a user when the user enters a queue; send a message to a user device of the user, the message containing a link to a web resource; receive a request from the user device to connect to the web resource; send a web page to the user device, the web page indicating the user's position in the queue and including a prompt to initiate a live chat session with an agent; receive a request from the user device to initiate the live chat session; and initiating the live chat session between the user and the agent to handle a request of the user.

In summary, in yet another form, a non-transitory computer readable storage media is provided that is encoded with software comprising computer executable instructions and when the software is executed operable to: receive a queuing request from a user when the user enters a queue; send a message to a user device of the user, the message containing a link to a web resource; receive a request from the user device to connect to the web resource; send a web page to the user device, the web page indicating the user's position in the queue and a prompt to initiate a live chat session; receive a request from the user device to initiate the live chat session with an agent; and initiating the live chat session between the user and agent to handle a request of the user.

Described above are examples. The concepts described herein may be embodied in other specific forms without departing from the spirit or essential characteristics thereof. The foregoing examples are therefore to be considered in all respects illustrative and not meant to be limiting. Accordingly, it is intended to embrace all such alterations, modifications and variations that fall within the spirit and scope of any claims filed in applications claiming priority hereto interpreted in accordance with the breadth to which they are fairly, legally and equitably entitled.

What is claimed is:

1. A computer-implemented method for providing customer queuing management, the method comprising:
at an application server, receiving a queuing request from a user when the user enters a queue;
sending a message to a user device of the user, the message containing a link to a web resource;
receiving a request from the user device to connect to the web resource;
sending a web page to the user device, the web page indicating the user's position in the queue and including a prompt to initiate a live chat session;
receiving a request from the user device to initiate the live chat session with an agent; and
initiating the live chat session between the user and the agent to handle a request of the user.

2. The method of claim 1, wherein the web page further contains a personalized advertising area to display one or more targeted advertisements on the user device to the user.

3. The method of claim 2, further comprising selecting the one or more targeted. advertisements for the user based on the user's past activities or based on the user's request.

4. The method of claim 3, wherein the user's past activities include one or more of browsing activity on a retailer's website or social media activity of the user.

5. The method of claim 1, wherein the live chat session is one of: text-based messaging, multimedia-based messaging, an audio conversation over Voice over Internet Protocol (VoIP), regular phone call in which the customer agrees to have a representative call a phone number associated with the mobile device, or a face-to-face video chat using a front-screen camera on the mobile device.

6. The method of claim 1, wherein the web page displays the user's position in the queue and an estimated wait time.

7. The method of claim 1, wherein the message is one of: a Short Message Service (SMS) message to a phone number associated with the mobile device, a Multimedia Messaging Service (MMS) message to a phone number associated with the mobile device, or a social media message to a social media account associated with the customer.

8. A system configured to provide customer queuing management, the system comprising:
a network interface configured to receive and transmit network communications;
one or more processors coupled to the network interface and configured to execute computer program instructions to:
receive a queuing request from a user when the user enters a queue;
send a message to a user device of the user, the message containing a link to a web resource;
receive a request from the user device to connect to the web resource;
send a web page to the user device, the web page indicating the user's position in the queue and including a prompt to initiate a live chat session;
receive a request from the user device to initiate the live chat session with an agent; and
initiating the live chat session between the user and the agent to handle the request of the user.

9. The system of claim 8, wherein the web page further contains a personalized advertising area to display one or more targeted advertisements on the user device to the user.

10. The system of claim 9, wherein one or more processors are further configured to select the one or more targeted advertisements for the user based on the user's past activities or based on the user's request.

11. The system of claim 10, wherein the user's past activities include one or more of browsing activity on a retailer's website or social media activity of the user.

12. The system of claim 8, wherein the live chat session is one of: text-based messaging, multimedia-based messaging, an audio conversation over Voice over Internet Protocol (VoIP), a regular phone call in which the customer agrees to have a representative call a phone number associated with the mobile device, or a face-to-face video chat using a front-screen camera on the mobile device.

13. The system of claim 8, wherein the web page displays the user's position in the queue and an estimated wait time.

14. The system of claim 8, wherein the message is one of: a Short Message Service (SMS) message to a phone number associated with the mobile device, a Multimedia Messaging Service (MMS) message to the phone number associated with the mobile device, or a social media message to a social media account associated with the customer.

15. A non-transitory computer readable storage media encoded with software comprising computer executable instructions and when the software is executed operable to:
receive a queuing request from a user when the user enters a queue;
send a message to a user device of the user, the message containing a link to a web resource;
receive a request from the user device to connect to the web resource;
send a web page to the user device, the web page indicating the user's position in the queue and including a prompt to initiate a live chat session;
receive a request from the user device to initiate the live chat session with an agent; and
initiating the live chat session between the user and the agent to handle a request of the user.

16. The non-transitory computer readable storage media. of claim 15, wherein the web page further contains a personalized advertising area to display one or more targeted advertisements on the user device to the user selected based on the user's past activities or based on the user's request.

17. The non-transitory computer readable storage media of claim 16, wherein the user's past activities include one or more of browsing activity on a retailer's website or social media activity of the user.

18. The non-transitory computer readable storage media of claim 15, wherein the live chat session is one of: text-based messaging, multimedia-based messaging, an audio conversation over Voice over Internet Protocol (VoIP), a regular phone call in which the customer agrees to have a representative call a phone number associated with the mobile device, or a face-to-face video chat using a front-screen camera on the mobile device.

19. The non-transitory computer readable storage media of claim 15, wherein the web page displays the user's position in the queue and an estimated wait time.

20. The non-transitory computer readable storage media of claim 15, wherein the message is one of: a Short Message Service (SMS) message to a phone number associated with the mobile device, a Multimedia Messaging Service (MMS) message to the phone number associated with the mobile device, or a social media message to a social media account associated with the customer.
